(19) United States
(12) Patent Application Publication
(10) Pub. No.: US 2009/0224962 A1
(43) Pub. Date: Sep. 10, 2009

(54) Apparatus And Method For Sensors Having Improved Angular Resolution

(76) Inventors: Hsueh-Yuan Pao, San Jose, CA (US); Binh Nien Tran, San Ramon, CA (US)

Correspondence Address: LATHROP & GAGE LLP, 4845 PEARL EAST CIRCLE, SUITE 201, BOULDER, CO, 80301, US

(21) Appl. No.: 12/240,743

(22) Filed: Sep. 29, 2008

Related U.S. Application Data
(60) Provisional application No. 60/976,318, filed on Sep. 28, 2007.

(51) Int. Cl. G01S 13/00; G01C 3/00; G01S 15/00; H01J 40/00

(52) U.S. Cl. 342/179; 356/3; 367/87; 250/200

(57) ABSTRACT

An imaging or echolocation system has a source of coherent waves, such as acoustic and electromagnetic waves, that are transmitted towards any target or targets of interest. Any waves reflected or echoed by the target or targets are received by a receiver further having many sensor elements spaced across a surface. A reference signal of the same frequency of the waves as received from received waves. A least one phase amplifier receives signals from at least one sensor element, and amplifies phase differences between the reference signal and the received waves. In imaging systems, signals from the phase amplifier(s) enter image construction apparatus and are used for constructing an image; in echolocation systems, signals from the phase amplifiers are used to distinguish between and identify targets. In various embodiments, phase amplifiers may be implemented in analog or digital form.

### RELATED APPLICATIONS

The present application claims the benefit of priority to Provisional Application Ser. No. 60/976,318 filed Sep. 28, 2007, which is incorporated herein by reference.

### FIELD

The present application relates to the field of echo-location and echo-imaging systems, including radar, sonar, and lidar systems, medical ultrasound, and other imaging systems that use coherent electromagnetic or acoustic waves.

### BACKGROUND

Existing echo-location and echo-imaging systems, including radar, sonar, and lidar systems, medical ultrasound, forward imaging systems, such as transmission imaging, scattering imaging, and diffraction, and other imaging systems using coherent electromagnetic or acoustic waves, such as those that may typically have a transmitter for emitting coherent waves for “illuminating” one or more targets. This transmitter may incorporate one or more of radio frequency or microwave transmitters, infrared or optical lasers, or may include ultrasonic transducers.

The coherent waves are reflected by the one or more targets towards receiving and/or imaging apparatus, hereinafter receiver, that may, but need not, be collocated with the transmitter. These reflected waves are an echo or echoes.

It is desirable to determine the number and locations, and other qualities such as speed, of targets, or to produce quality images from, information embedded in reflected waves and echoes. For example, a warship's crew may respond quite differently if it can be determined that echoes are being received from a single, large, transport aircraft instead of several small aircraft flying in a tight formation.

Radar, lidar, active sonar, and medical ultrasound systems may use round-trip “time-of-flight” information to determine distance from the receiving and/or imaging apparatus, they may also use Doppler-shift of echoes to determine target speed and the velocity of blood flow. It is also desirable to discriminate between, or image, targets based upon the direction, or angle, from which echoes are received—for which good angular resolution is required. The minimum angle that must separate two targets for the system to reliably determine that echoes are from two, and not one larger target, is the angular resolution of the system. Good angular resolution is of importance in medical imaging, and sonar, as well as radar, since imaging of a large target is equivalent to studying many smaller, closely spaced, targets.

Classically, a limit for angular resolution of a receiving and/or imaging system is related to the wavelength of the waves and the aperture size, or the greatest distance between elements, of the receiver.

### Resolution

Resolution refers to the ability to distinguish closely spaced signal sources. The angular resolution of the classical sensor is given by the diffraction angle λ/D of the array aperture; the field of view is Nλ/D for N elements. To see this, consider a plane wave incident on a one-dimensional antenna array with N elements and aperture D, which we assume is the limiting aperture in the system. The signal received at the array aperture in angular space ψ from a point source far away has the form:

$$AF = {e}^{i ( N - 1 ) \frac{kd}{2} ( sin Ψ - sin θ )} \frac{sin \frac{[ Nkd ( sin Ψ - sin θ ) ]}{2}}{sin \frac{[ kd ( sin Ψ - sin θ ) ]}{2}} {e}^{- i ω t} , \qquad ( 1 )$$

Where θ is the angle of incident on the detector, k=2π/λ, λ is the wavelength, ω is the operating angular frequency, d is the separation between the elements. A typical angular signal strength distribution is plotted in FIG. 3. A target is imaged as a finite-sized spot by the conventional imaging system. The minimum spot dimension obtained for point-like objects is determined by two zero signal strength angular positions adjacent the maximum signal strength. This means that the argument of the sine term in the numerator of equation (1) should span an integral multiple of π. They are at Nkd(sin ψ−sin θ)=π, and Nkd(sin ψ-sin θ)=−π. Consequently the spot size is:

$$Δ sin θ = \frac{λ}{Nd} . \qquad ( 2 )$$

If θ is small enough, we have:

$$Δ θ = \frac{λ}{Nd} = \frac{λ}{D} . \qquad ( 3 )$$

Nd in equations (2) and (3) is called numerical aperture (NA) and is the size of the array aperture D. The spot size (3) is called point-spread function (PSF), it can be used as a convention criterion to define a limit to the minimum angular separation below which two nearby objects can not be distinguished as clearly providing two peaks, see FIG. 4. It has been known for some time that this criterion, the Rayleigh Limit, is the resolution limit of a classical system.

In past two decades, parameter estimation has been an area of focus by applied statisticians and engineers. As applications expanded the interest in accurately estimating relevant temporal as well as spatial parameters grew. Sensor array signal processing emerged as an active area of research and was centered on the ability to fuse, that is, to process, analyze, and/or synthesize, data collected at several sensors in order to carry out a given estimation task (space-time processing). This framework has the advantage of prior information on the data acquisition system (i.e. array geometry, sensor characteristics). The methods have proven useful for solving several real world problems. One of most notable is for source location. It demonstrated the possibility that the processing developed such as MUltiple SIgnal Classification (MUSIC) algorithm, which uses the eigenvector decomposition method or signal subspace approach, might be a superresolution algorithm useful to locate closely spaced multiple emitters (targets) with high resolution (smaller than the Rayleigh Limit).

However, the Cramer-Rao Bound principle,

$$Resolution \sim \frac{λ}{D \sqrt{Energy}} , \qquad ( 4 )$$

named in honor of Harald Cramér and Calyampudi Radhakrishna Rao, expresses a lower bound on the variance of estimators of a deterministic parameter. It is the “best” in a minimum error variance sense (lower bound) that an estimator can achieve. In a statistical setting, assumptions can be made regarding statistical properties of the signal and/or noise

In conclusion, the resolution obtained in classical sense might, with MUSIC, be better than Rayleigh Limit, but never better than Cramer-Rao Bound.

Since the Raleigh Limit has been known for many years, prior systems for improving angular resolution of a system have often involved increasing operating frequency, thereby decreasing wavelength λ, or alternatively increasing aperture size D. There are often practical limitations to either. For example, waves, whether sonic or electromagnetic, of differing wavelengths may propagate differently—for example short radar wavelengths may be limited to line of sight while atmospheric ionization may allow longer radar wavelengths to follow the earth's curvature thereby allowing detection of targets at greater distances from the imaging system. Similarly, receivers having a large physical aperture size D may be unwieldy.

### SUMMARY

An imaging or echolocation system has a source of coherent waves, such as acoustic and electromagnetic waves, that are transmitted towards any target or targets of interest. Any waves reflected or echoed by the target or targets are received by a receiver further having many sensor elements spaced across a surface. A reference signal of the same frequency of the waves as received from received waves. A least one phase amplifier receives signals from at least one sensor element, and amplifies phase differences between the reference signal and the received waves. In imaging systems, signals from the phase amplifier(s) enter image construction apparatus and are used for constructing an image; in echolocation systems, signals from the phase amplifiers are used to distinguish between and identify targets. In various embodiments, phase amplifiers may be implemented in analog or digital form.

### BRIEF DESCRIPTION OF THE FIGURES

FIG. 1 is a block diagram illustrating transmitter, receiver, and angular separation between two targets as viewed by a device of present invention.

FIG. 2 is an illustration showing details of targets and a detector, according to an embodiment.

FIG. 3 is an illustration of an angular signal strength from a single target in prior art or the present systems.

FIG. 4 is an illustration of an angular signal strength from a pair of closely spaced targets in prior art systems.

FIG. 5 illustrates the effect of phase-difference amplification on angular resolution in a complex phase/amplitude diagram.

FIG. 6 illustrates phase amplification in field-quadrature phase space.

FIG. 7 is a block diagram of an individual phase amplifier.

FIG. 8 is a block diagram of an echolocation or imaging system embodying the phase amplifier of FIG. 7.

FIG. 9 is a block diagram of an echolocation or imaging system having a separate transmitter.

FIG. 10 is a block diagram of an alternative embodiment of an individual phase amplifier.

FIG. 11 is an illustration of the effect of a phase amplifier in field-quadrature phase space.

FIG. 12 illustrates simulated performance of normal radar using a 10 GHz, 64-element phased array with 0.003 radian separation between targets.

FIG. 13 illustrates simulated performance of a radar system using the same array and angular separation between targets, but with an 8× phase amplifier.

FIG. 14 illustrates an embodiment using digital signal processing, such as may be used for Sonar or Ultrasonic Imaging, or adapted to RF-frequency radar And applications to LIDAR.

### DETAILED DESCRIPTION OF THE EMBODIMENTS

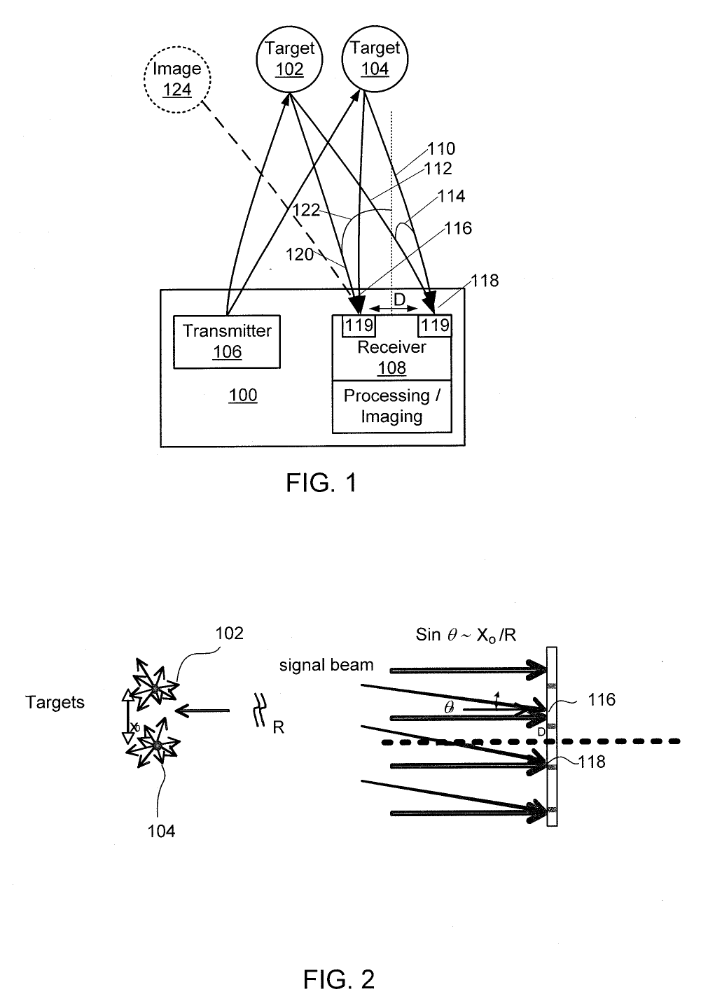

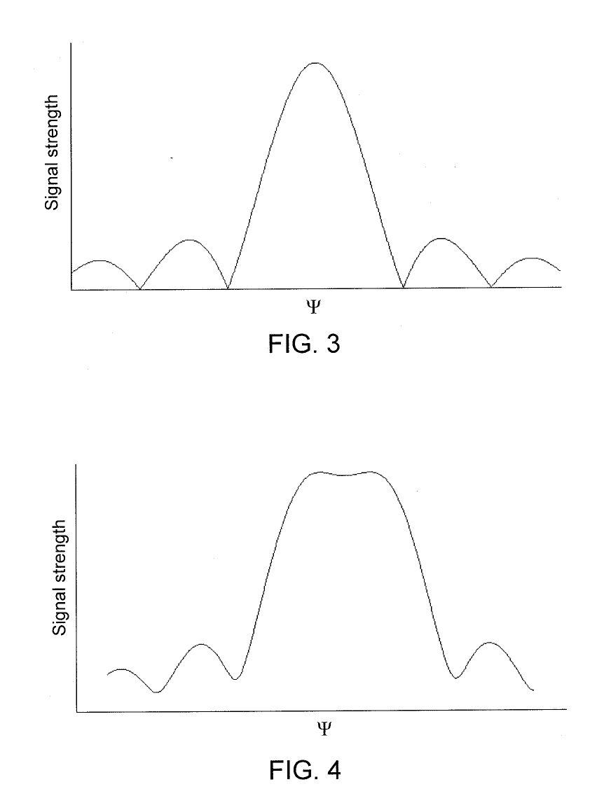

FIG. 1 illustrates an imaging or target identification system 100 in use. Targets, such as targets 102, 104, are illuminated with coherent waves of a known wavelength λ by a transmitter 106, waves reflected by targets 102, 104 are received by a receiver 108. In the event that there is more than one target 102, 104, waves from the targets 110, 112, arrive at the receiver 108 from directions separated by an angle θ 114.

Phase Difference Corresponds to Angle from Perpendicular

Arriving waves from the two targets 102, 104 in FIGS. 1 and 2 strike receiver 108 at two or more places 116, 118, separated by a distance D that corresponds to the aperture. In ultrasonic, radio frequency, and microwave applications a sensor element 119, such as a piezoelectric transducer or a phased-array antenna element, may be located at each of places 116, 118 of the receiver. The path 120 length from a target 102 to one of these places 116 on receiver 108 is equal to the path length from target 102 to a different place 118 on receiver 108 only if the target 102 is located at a point perpendicular to the midpoint of a line between the places 116, 118 on the receiver. As an angle 122 from the perpendicular to the path 120 increases, a phase difference between the signals received by the receiver 108 at the first place 116 and second place 118 from that target increases. Each target 102, 104 will produce signals at the sensors 119 at first 116 and second 118 places at the receiver 108 that differ in phase by different amounts for each target. The angular resolution of a system is equivalent to the ability to distinguish between arriving signals having differing phase-differences at separated points 116, 118 on receiver 108.

The devices we propose exploits the fact that the coherent detection on the focal plane converts a problem in spatial or angular resolution of a target to one of resolution in phase, and the fact that faster phase variation implies higher resolution. Our approach does this by adding to the classical sensor described above a quantum phase amplifier (QPA).

Suppose we could increase the phase differences of the incident plane wave by a scale factor g prior to detection: this would have the effect of increasing the fringe spatial frequency across the array. Then equation (1) would become:

$$AF = {e}^{i ( N - 1 ) \frac{kd}{2} ( sin Ψ - sin g θ )} \frac{sin \frac{[ Nkd ( sin Ψ - sin g θ ) ]}{2}}{sin \frac{[ kd ( sin Ψ - sin g θ ) ]}{2}} {e}^{- i ω t} , \qquad ( 5 )$$

immediately leading to the angular resolution (analogously to equation (3)),

$$Δ θ \approx \frac{λ}{gD} . \qquad ( 6 )$$

The QPA does not increase the operating frequency, but introduce a phase shift in the incident field proportional to its local phase as compared to a reference phase φref, i.e., Δφ=(g−1)(φ−φ_{ref}).

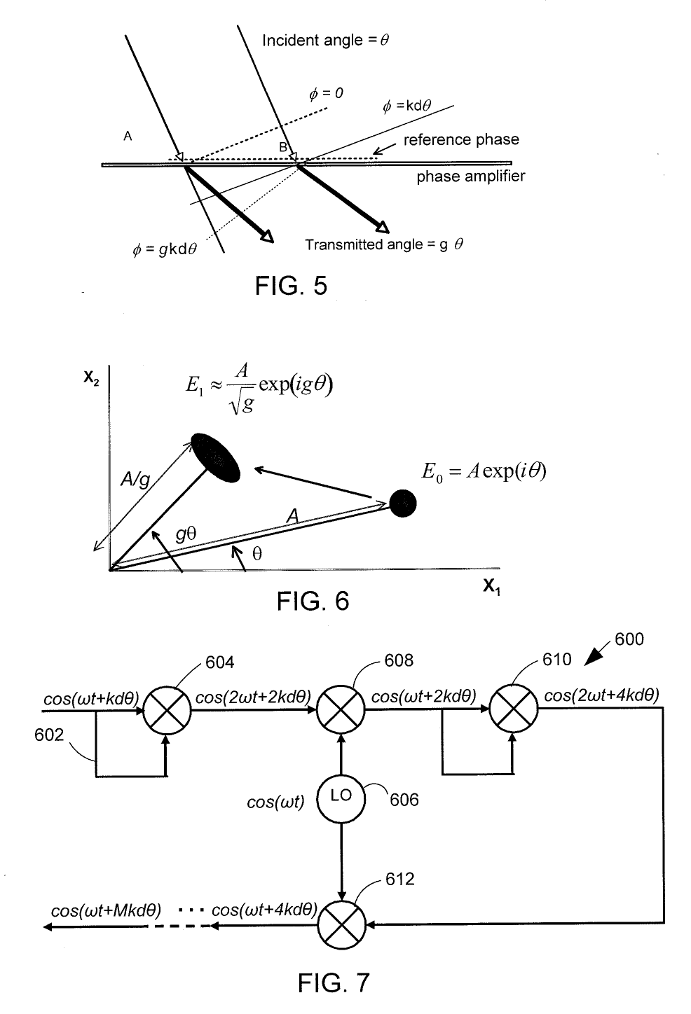

We can picture the effect of the QPA by referring to FIG. 5. A plane wave is incident on the planar surface of the phase amplifier, its phase varying linearly across the surface according to the angle between the perpendicular and path from the target from which the waves are arriving. Referring to point A in the figure, suppose the local phase is equal to the reference phase, φ=φ_{ref}=0 (dashed line phase front). At point B, a distance d to the right, the local relative phase is larger, φ=kdθ (dotted line phase front). Below the phase amplifier, the phase at A is unchanged (φ=gφ=0), but the phase at B experiences a shift, advancing to φ=gkdθ. To find the direction of the transmitted wave, we form the line of constant phase φ=gkdθ, indicated by the dot-dashed line. We see that the wavefront of the transmitted wave is tilted away from the normal direction. The net result is as if the wave has entered a medium of smaller refractive index, of magnitude 1/g, but without inducing a shift in wavelength.

### Effect of Phase Amplification

The effect of the phase amplifier in the coherent imaging system is depicted in FIG. 1, where we illustrate phase amplification's increasing the rate of change of phase at the detector. The magnification of the incident angle increases the apparent position of the off-axis target 102, producing an apparent target image 124 separated by a greater angle from the nearly on-axis target 104. Thus, we can summarize by stating that we achieve resolution enhancement by magnification of the angular separation of targets.

To visualize the phase amplification process, we can look at its action on a coherent state in the phase plane whose coordinates are the real and imaginary parts of the electric field (FIG. 6). The initial coherent state can be depicted as a circle, which represents the uncertainty area (quantum noise) of the complex field amplitude. The squared magnitude of the field amplitude, A², is equal to the mean photon number in the state. Under phase amplification, the mean photon number is diminished, while the phase, which is canonically conjugate to the photon number, is increased by the same factor. The final state is nonclassical, having been squeezed in amplitude and antisqueezed in phase; the uncertainty area is now elongated in the phase direction.

Note that both the phase and the phase noise have been amplified. However, phase amplification may preserve or improve the overall SNR, as mentioned above.

In order to build the phase amplifier for the frequency of interest, we must figure out how to generate the squeeze state realized by this frequency.

### Active Approach

An active phase amplifier or QPA 600 is illustrated in FIG. 7.

A signal at QPA 600 input 602 is representable as cos(ωt+kdθ).

The input signal is applied to a first frequency doubler 604 that operates by mixing the input with itself, with output taken through a filter as the upper harmonic, giving cos(2ωt+2 kdθ). A source 606 of a reference signal having frequency co, the fundamental frequency of the signal arriving from the targets, is provided. The signal from the first frequency doubler 604 is mixed with the reference 606 signal at the second mixer 608, and take the lower harmonic is selected by a filter. The filtered signal at the second mixer 608 output is cos(ωt+2kdθ). Phase differences from the reference to the input signal are now doubled.

The filtered signal at the second mixer 608 output is applied to a second frequency doubler 610 that operates by mixing the input with itself, with output taken through a filter as the upper harmonic, giving cos(2χt+4kdθ). We then mix this signal again with reference 606 signal at the fourth mixer 612, and take the lower harmonic, we have the signal cos(ωt+4kdθ). We now have the 4× gain phase gain desired in this particular embodiment. Every two mixers complete one phase doubling operation, we call this one multiply. If there are M multiples we have the gain of 2^{M}. Necessary amplifiers and filters have been omitted from FIG. 7 for simplicity. Although this embodiment features phase multiples in the form 2^{M}, one of ordinary skill in the art, after reading and comprehending the present disclosure, will understand that the present invention is not limited to only this form. Other indirect methods are available to estimate the phase multiples, as well as other terms.

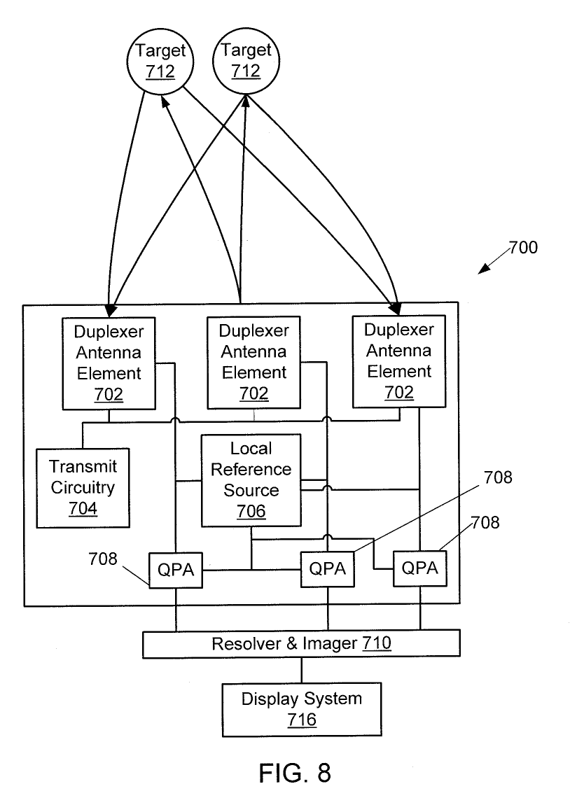

FIG. 8 illustrates a phased-array echolocation or imaging radar system 700 embodying the phase amplifier of FIG. 7. The system has an array of N, N at least two and chosen for cost and good resolution, sensor elements, or diplexer-antenna elements, 702 in an array. For simplicity only three of the N sensor elements 702 are shown in FIG. 8. Transmitter circuitry 704 is provided as known in the art. In the embodiment of FIG. 8, the same antennas are used for transmitting illumination as for receiving echoes, so duplexing circuitry is incorporated in diplexer-antenna elements 702 to prevent receiver burnout.

In the embodiment of FIG. 8, coherent radiation is transmitted in pulses, once a transmit pulse is ended the diplexer circuitry permits sensor elements 702 to receive any echoes from the targets. In an alternative embodiment, chirp-modulated pulses alternate with constant-frequency pulses, echoes from the chirp-modulated pulses being processed as known in the art for high resolution in range, echoes from the constant-frequency pulses being processed as described herein for high angular resolution.

A local reference source 706 is coupled to at least one sensor element 702. In order to prevent Doppler effects from affecting the QPA 708, this reference source 706 may be a local oscillator phase-locked to the echo as received by one predetermined sensor element 702 of sensor elements 702, or alternatively to a signal derived from an average of several sensor elements. In another embodiment, the reference signal source 706 buffers echo received by one predetermined sensor element 702. In other embodiments, such as those where targets are stationary, the reference source may be tapped from the transmitter 704. The output of reference source 706 is applied as a common reference to the reference 606 (FIG. 7) of each QPA 708.

Each sensor element 702 feeds one of identical QPAs 708 with phase gain g. The input signals at each of the QPAs 708 are effectively 1, e^{-j(ωt+kdθ)}, e^{-j(ωt+2kdθ)}, . . . , e^{-j(ωt+Nkdθ)}. The N outputs of the QPAs 708 are 1, e^{-j(ωt+kdgθ)}, e^{-j(ωt+kdgθ)}, . . . , e^{-j(ωt+Nkdgθ)}.

The QPAs therefore operate as phase-difference amplifiers, amplifying a phase shift between reference 706 and the signals received through sensor elements 702.

Outputs from QPAs 708 feed a resolver and/or imager 710. Resolver and/or imager 710 uses conventional beam forming techniques or parameter estimating algorithms such as MUSIC to resolve any targets 712, or form images of any targets 712, that may be present. Resolver and/or imager 710 provide information to a display system 716 as known in the art. Resolver and/or imager 710 may act to resolve separate targets directly, or may act to form a narrow beam that may then be scanned by other apparatus to identify the targets.

FIG. 8 can be viewed as illustrating a pulsed active sonar system by replacing diplexer-antenna elements as sensor elements 702 with piezoelectric transducers and transmit-receive switching circuitry as sensor elements 702, and adjusting operating frequencies appropriately.

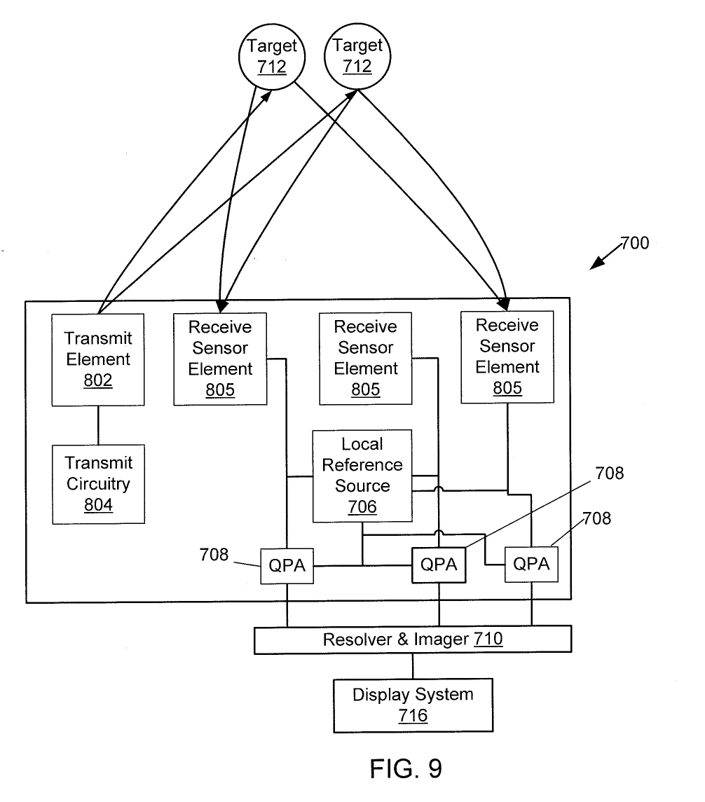

In an alternative embodiment, as illustrated in FIG. 9, the source of coherent acoustic or electromagnetic illumination may be separated from the receiving array. A system of this type may use either continuous standing-wave illumination or pulsed illumination. In this embodiment, a transmitter 804 feeds a transmit antenna or transducer 802 to emit coherent waves towards any target or targets that may be present. Signals reflected from the target or targets are received by receive sensor elements 805. The remainder of blocks in FIG. 9 greatly resemble equivalent blocks in FIG. 8 and will not be separately described herein.

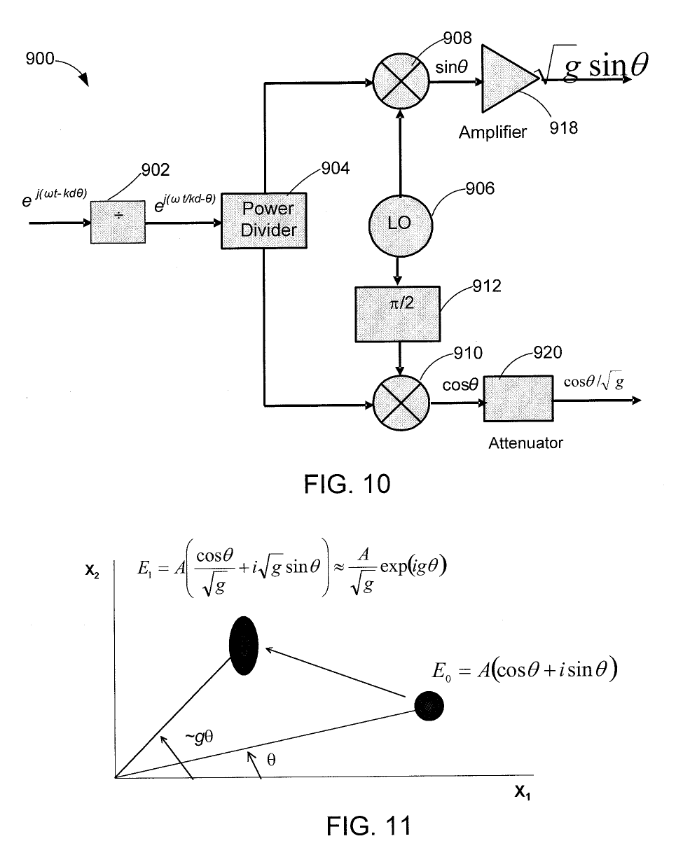

In an alternative embodiment of the phase amplifier as a degenerate squeeze state generator is illustrated in FIG. 10. This embodiment uses an approximation of the action of a phase amplifier in field quadrature phase space as illustrated in FIG. 11.

It is desirable that only one field quadrature will be amplified, while the other will be deamplified. We see that for small angles θ˜X₂/X₁, the degenerate squeeze state generator provides gain to the phase and deamplifies the amplitude, i.e., it behaves like a quantum phase amplifier.

In the embodiment of phase amplifier 900 (FIG. 10), an IF signal, such as may be derived from an antenna-diplexer-downconverter element 702 (FIG. 8), e^{j(wt-kdθ)} inputs to the squeeze state generator through a frequency divider 902 first. The signal is e^{j(ωt/kd-θ)} at the frequency divider 902 output. In this balanced configuration, this divider output passes through splitter 904 into two equal amplitude and two equal phase signals. The reference signal 906 is combined with the signal at two mixers 908, 910 with a 90° phase difference between them, here induced by phase shifter 912. Two outputs from the mixers 908, 912 at baseband represented the real part and the imaginary part of the incoming signal which associate with the X₁ and X₂ quadrature in FIG. 11, respectively. The imaginary part signal passes through a amplifier 918 by providing gain to the X₂ quadrature, while the real part signal path cascades a deamplifier 920 (attenuator) which squeezes the X₁ quadrature. These signals may then be used by resolver and imager 710 to form an effective beam and/or further processing to derive an image.

The alternate embodiment of FIG. 10 could be realized in both analog domain and digital domain, which opens a wide door for this invention's validity in metrology (instrument, CCD), remote sensing (RADAR, microwave and RF), and imaging (Lithography, Ultrasound, CT, MRI, PET and nuclear scanning). Taking the advantage of the digital implementation will allow existing systems to be usable with only a small portion of software code added.

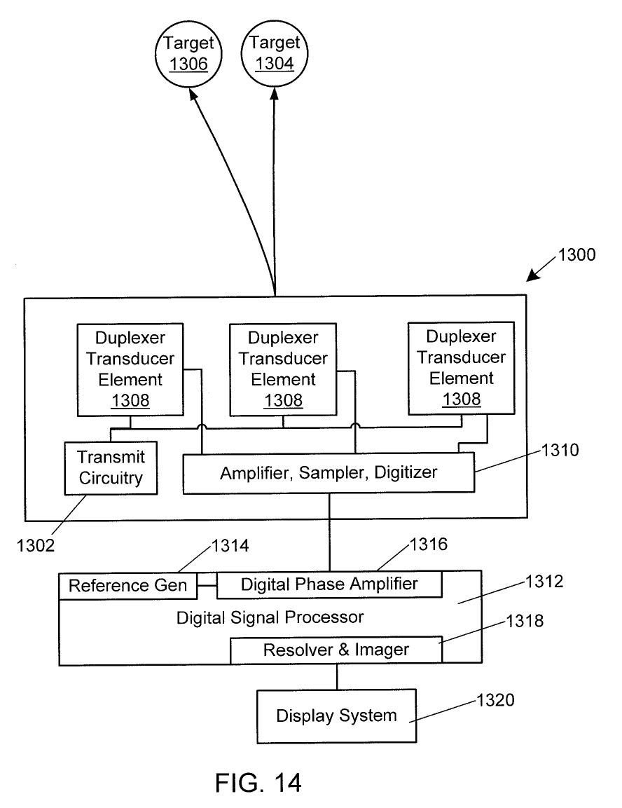

An alternate embodiment of the system 1300 is illustrated in FIG. 14. In this embodiment, transmitter circuitry 1302 generates a pulse of coherent acoustic or electromagnetic waves, these are transmitted to any targets that may be present 1304, 1306 through two or more duplexer-transducer elements 1308. Received signals, such as reflections and echoes from targets 1304, 1306 enter through duplexer-transducer elements 1308. These signals are then amplified, down converted by mixers if necessary, sampled, and digitized by multichannel amplifier, sampler, digitizer 1310. Digital signals representative of signals received by each duplexer-transducer element 1308 are passed from digitizer 1310 to a digital signal processor 1312.

Digital signal processor 1312 implements reference signal recovery 1314, similar to the function of local reference 706 previously described with reference to FIG. 8. The recovered reference from reference recovery 1314 and signals representative of signals received by each duplexer-transducer element 1308 are passed to digital phase amplifier 1316, which implements a sampled-data equivalent of the phase amplifier circuitry of FIG. 7 or FIG. 10. Once phase-amplified, resolver and imager 1318, uses conventional or MUSIC methods to identify the targets and resolve images, which are then passed to a display 1320.

A first embodiment of the system of FIG. 14 is a sonar system for mapping the ocean bottom and for identifying submerged objects. A second embodiment is an ultrasonic imaging device for imaging internal organs of patients. A third embodiment is an over-the-horizon radar system.

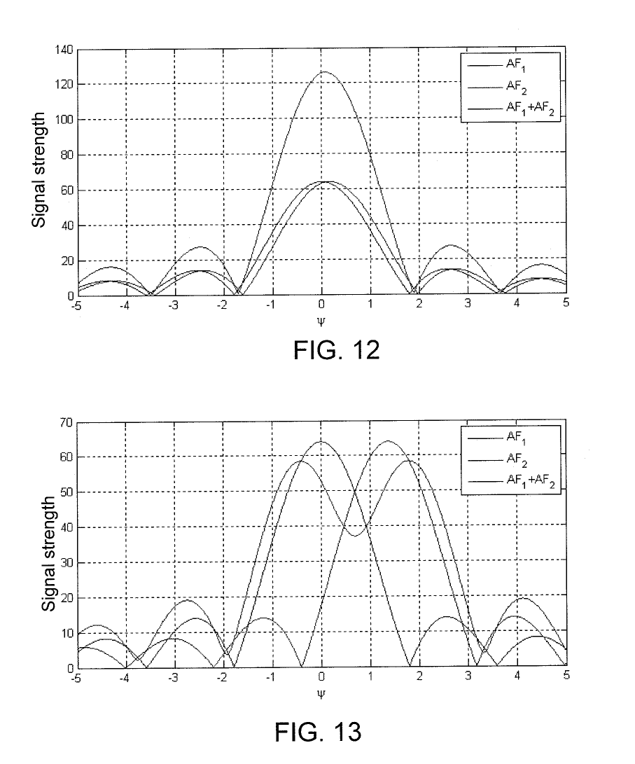

FIG. 12 illustrates simulated performance of normal radar using a 10 GHz, 64-element phased array with 0.003 radian separation between targets. The separation between elements is d=λ/2. One signal impacts the array normally, while another incidents from 0.003 radians. The resolution is far below the classic Rayleigh Limit, as shown by the angular signal strength distribution. Depicted are two incident waves, and an overall signal. The sensor is unable to distinguish two signals from the overall signal.

FIG. 13 illustrates simulated performance of a radar using the same array and angular separation between targets, but incorporating an 8× phase amplifier. The resulting overall signal clearly has a bimodal distribution, indicating presence of two targets instead of one target. It is clear the sensor is able to distinguish two incident signals. The QPA concept presented therefore promises to achieve resolution beyond classic Rayleigh Limit and possibly the Cramer-Rao Bound.

### Passive Approach

In this embodiment, a lens with a refractive index less than 1 but greater than 0, such as may be constructed of an artificial material such as a metamaterial, is added as a covering or coating on the sensor array. With such a material, Refraction angle is away from the normal of the antenna array by the nature of the lens material, and effective phase amplifying is achieved as the incident wavefront arrives at the sensor array behind the lens.

A material with a refractive index less than unity is referred to as a phase-advance material since the phase change per unit length for a wave traveling in such a material is less than that if the wave was traveling in free-space. This implementation generally requires such a phase-advance material for microwave or optical lens application.

Metamaterials having microwave refractive index less than one have been demonstrated under laboratory conditions. Metamaterials are typically static assemblies of a particular geometry and material that can be tuned to provide desired properties. In optics and electromechanical applications, such as with RF and microwave signals, for example, lenses and gratings are typically constructed of homogenous materials having particular shapes. As utilized in the embodiments disclosed herein, metamaterials depart from this conventional approach in that they can be non-homogenous constructed devices that exhibit passive behavior normally associated with regular materials. In some applications, the metamaterials act like a band-pass filter, except according to the present embodiments, phase can be filtered, and not just frequency. By filtering phase components, significantly greater measurement resolution can be realized with respect to time, angle, and other measured components.

Whereas the active approach, described above, can be particularly advantageous for use with digital processing, RADAR, and ultrasound applications, this passive approach is seen by the present inventors to have significant advantages where light applications, such as LIDAR, are also present. One advantage of this passive approach is that it is capable of bypassing stringent requirements seen when dealing with “non-classical” light situations. This passive approach further allows for a more general implementation for various types of signals, including at least those described above.

### Heisenberg Scaling

The phase amplifier achieves Heisenberg resolution scaling, R˜1/Energy or R˜1/N for N received photons per unit time. One way is simply to consider equation (6), which shows R˜1/g. The maximum g value is just given by the mean photon (or phonon) number N, although phase noise limits this gain to a somewhat lower value. This implies R˜1/N. In particle sense, the energy is carried by the particles; therefore, the energy is proportional to the particle number. Consequently, the resolution is proportional to 1/Energy, which is the Heisenberg scaling.

Suppose we wish to resolve two coherent-state plane waves whose propagation directions differ by an angle φ. This means that the photon states have mean phase values equal to, say 0 and φ, the variances of which scale as [symbol] δφ² [symbol] ∝1/N for N mean photons in the mode. The incident beams have angular Gaussian distribution, whose bandwidths are σ_{φ}. Since the angular separation between two beans is φ, we define the resolution proportional to the ratio of the angular beam width over the angular separation. These phase distributions are distinguishable if R˜σ_{φ}/φ˜(φ\sqrt{N})⁻¹ is small enough. After phase amplification, φ→gφ and σ_{φ}→\sqrt{g/N}, so after post-amplification the resolution is R˜φ⁻¹(gN)^{-1/2}. But, again, the maximum g value is just given by the mean photon number N; this implies R˜1/N. Since the photon number has been squeezed g times, the energy; therefore, is reduced g times as well. If we want to improve the Signal-to-Noise-Ratio (SNR), at a fixed number of post-amplification detected photons, we need to increase the transmitted power by a factor of g to achieve a g-fold improvement in resolution. This situation is completely analogous to the classical Heisenberg-like resolution attainable by increasing both power and frequency, except we do not need to propagate shorter wavelength photons to the target.

### Scaling to Increased Resolution

Gain g is a parameter in the QPA sensor, and the resolution enhancement is a factor of g. As described in the previous section, since the PA deamplifies the photon number by the same scale factor g, the maximum allowable gain is given simply by the mean photon number received from the target for fixed SNR, and the maximum gain is the ratio of the pre- to post-amplification photon number. Therefore, the theoretical resolution improvement scales directly with the power transmitted to the target. Practically, one will be limited by the feasibility of attaining high gain amplification. In addition, the effect of phase noise due to atmospheric turbulence must also be considered, since it too will increase with gain (as it would for propagating shorter wavelength).

While the forgoing has been particularly shown and described with reference to particular embodiments thereof, it will be understood by those skilled in the art that various other changes in the form and details may be made without departing from the spirit and hereof. It is to be understood that various changes may be made in adapting the description to different embodiments without departing from the broader concepts disclosed herein and comprehended by the claims that follow.

What is claimed is:

1. An imaging system, comprising:
a source of coherent waves selected from the group consisting of acoustic, light, and electromagnetic waves, the source further comprising apparatus for transmitting said waves;
a receiver for receiving waves, the receiver further comprising a plurality of sensor elements spaced across a surface;
a reference signal source;
at least one phase amplifier, each phase amplifier coupled to receive signals from at least one sensor element of the plurality of sensor elements; and
an image construction apparatus for receiving an output of the at least one phase amplifier and constructing an image.

2. The imaging system of claim 1, wherein the reference signal source comprises a local oscillator phase-locked to a signal derived from at least one of the sensor elements.

3. The imaging system of claim 1, wherein each phase amplifier comprises:
a first frequency doubler for receiving a signal from a sensor element; and
a mixer for mixing an output of the first frequency doubler with a signal from the reference signal source.

4. The imaging system of claim 1, wherein each phase amplifier comprises:
a frequency divider for receiving a signal from a sensor element of the plurality of sensor elements;
a mixer for mixing an output of the frequency divider with a first reference signal from the reference signal source; and
a second mixer for mixing an output of the frequency divider with a second reference signal from the reference signal source;
wherein the first reference signal is phase-shifted by approximately 90 degrees from the second reference signal.

5. The imaging system of claim 4, wherein the reference signal source is selected from the group consisting of a local oscillator phase-locked to a signal derived from signals from at least one of the sensor elements, and a buffered signal received from a predetermined sensor element.

6. The imaging system of claim 5, wherein the waves are acoustic.

7. The imaging system of claim 5, wherein the waves are electromagnetic.

8. An echolocation system, comprising:
a source of coherent waves selected from the group consisting of acoustic, light, and electromagnetic waves, the system further comprising apparatus for transmitting said waves;
a receiver for receiving waves, the receiver further comprising a plurality of sensor elements spaced across a surface;
a reference signal source;
at least one phase amplifier, each phase amplifier coupled to receive signals from at least one sensor element of the plurality of sensor elements; and
a target resolution apparatus.

9. The echolocation system of claim 8, wherein the reference signal source comprises a local oscillator phase-locked to a signal derived from at least one of the sensor elements.

10. The echolocation system of claim 8, wherein each phase amplifier comprises:
a first frequency doubler for receiving a signal from a sensor element; and
a mixer for mixing an output of the first frequency doubler with a signal from the reference signal source.

11. The echolocation system of claim 8, wherein each phase amplifier comprises:
a frequency divider for receiving a signal from a sensor element of the plurality of sensor elements;
a mixer for mixing an output of the frequency divider with a first reference signal from the reference signal source; and
a second mixer for mixing an output of the frequency divider with a second reference signal from the reference signal source,
wherein the first reference signal is phase-shifted by approximately 90 degrees from the second reference signal.

12. The echolocation system of claim 11, wherein the reference signal source is selected from the group consisting of a local oscillator phase-locked to a signal derived from signals from at least one of the sensor elements, and a buffered signal received from a predetermined sensor element.

13. The echolocation system of claim 12, wherein the waves are acoustic.

14. The echolocation system of claim 12, wherein the waves are electromagnetic.

15. The echolocation system of claim 10, wherein the reference signal source is selected from the group consisting of a local oscillator phase-locked to a signal derived from signals from at least one of the sensor elements, and a buffered signal received from a predetermined sensor element.

16. The echolocation system of claim 15, wherein the waves are acoustic.

17. The echolocation system of claim 15, wherein the waves are electromagnetic.

18. The echolocation system of claim 8, further comprising a digitizer for receiving signals from the plurality of sensors, and wherein the reference signal source and at least one phase amplifier are implemented in a digital signal processing system.

19. The imaging system of claim 1, wherein the at least one phase amplifier is a lens including a metamaterial.

20. The echolocation system of claim 8, wherein the at least one phase amplifier is a lens including a metamaterial.

21. The imaging system of claim 1, wherein the at least one phase amplifier is active.

22. The imaging system of claim 1, wherein the at least one phase amplifier is passive.

23. The echolocation system of claim 8, wherein the at least one phase amplifier is active.

24. The echolocation system of claim 8, wherein the at least one phase amplifier is passive.

25. The imaging system of claim 19, wherein the waves are light.

26. The echolocation system of claim 20, wherein the waves are light.
